(19) United States
(12) Patent Application Publication
(10) Pub. No.: US 2008/0018298 A1
(43) Pub. Date: Jan. 24, 2008

(54) Portable power supplier

(76) Inventor: Cheng-Kuang Wong, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/489,498

(22) Filed: Jul. 20, 2006

(51) Int. Cl. H02J 7/00

(52) U.S. Cl. 320/112

(57) ABSTRACT

The invention relates to a portable power supplier, which includes a box, some energy storage apparatus, and an IC board received therein. The box also has several supply sockets and a recharge socket on a side. The energy store apparatus can be charged with energy and the IC board is provided for connecting and transferring energy between the sockets and the apparatus. Hence, the box becomes a portable power supplier, which can be carried outside and used easily and safely for any electric equipments that obtains utilization and improvement.

### BACKGROUND OF THE INVENTION

Accompanying with change of society structure, more and more people go outside on holiday and have various kinds of fun, such as picnic, barbeque, or karaoke. Such playing usually needs electric power. A gas over can be used to cook or bake but it may lead danger of fire. It is known that electric power will be better for safety. Hence, people use battery of car as power supplier in tradition. But it is still inconvenient. For example, it needs a long electrical wire for connection and it must be used near a car, which have to keep run-on state while exhaust gas pollutes environment and makes people uncomfortable.

The present invention is to provide a portable power supplier for convenient use and safe use when people go outside. Now, accompanying with the following drawings, the character of the present invention will be described here and after.

### BRIEF DESCRIPTION OF THE DRAWINGS

FIG. 1 is a perspective view showing a portable power supplier according to the present invention.

FIG. 2 is a plan view showing a portable power supplier according to the present invention.

FIG. 3 is a perspective view showing an application of FIG. 1.

### DETAILED DESCRIPTION OF THE PREFERRED EMBODIMENT

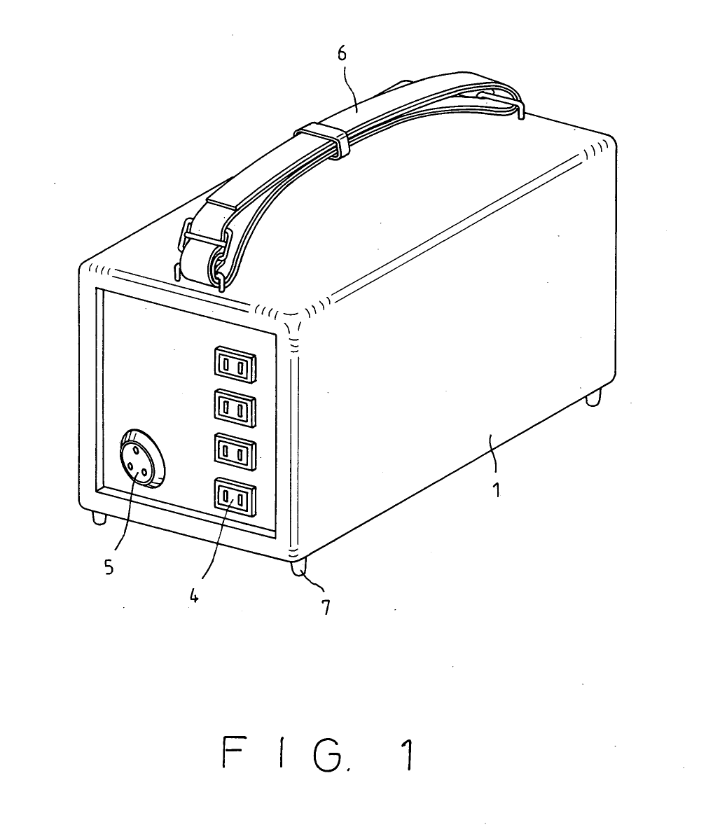

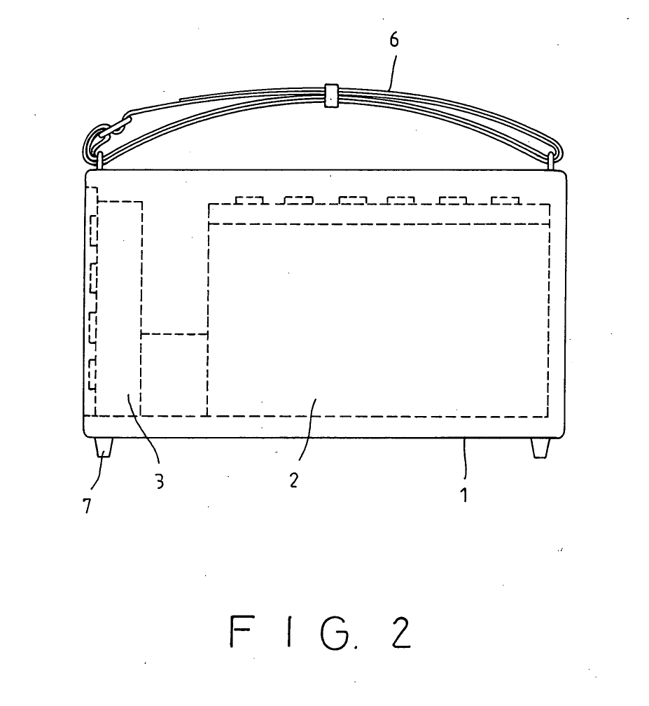

Referring to FIG. 1 and 2, the present invention relates to a portable power supplier, which includes mainly a box (1). In the box (1), some energy storage apparatus (2) is received, such as a rechargeable battery, an accumulator, a secondary cell, and so on. An IC board (3) is provided in the box (1) for connecting and transferring energy. The box (3) has several supply sockets (4) and a recharge socket (5) on one side. Further, an extendable belt (6) and some adjustable legs (7) can be connected with the box (3).

Before use, the energy store apparatus (2) can be charged fully in door through recharge socket (5) easily. And the box (3) becomes a portable power supplier to be used conveniently. It can be put anywhere for connecting with other electric equipments, which can just use the plug to insert into the supply socket (4) directly and will be worked on.

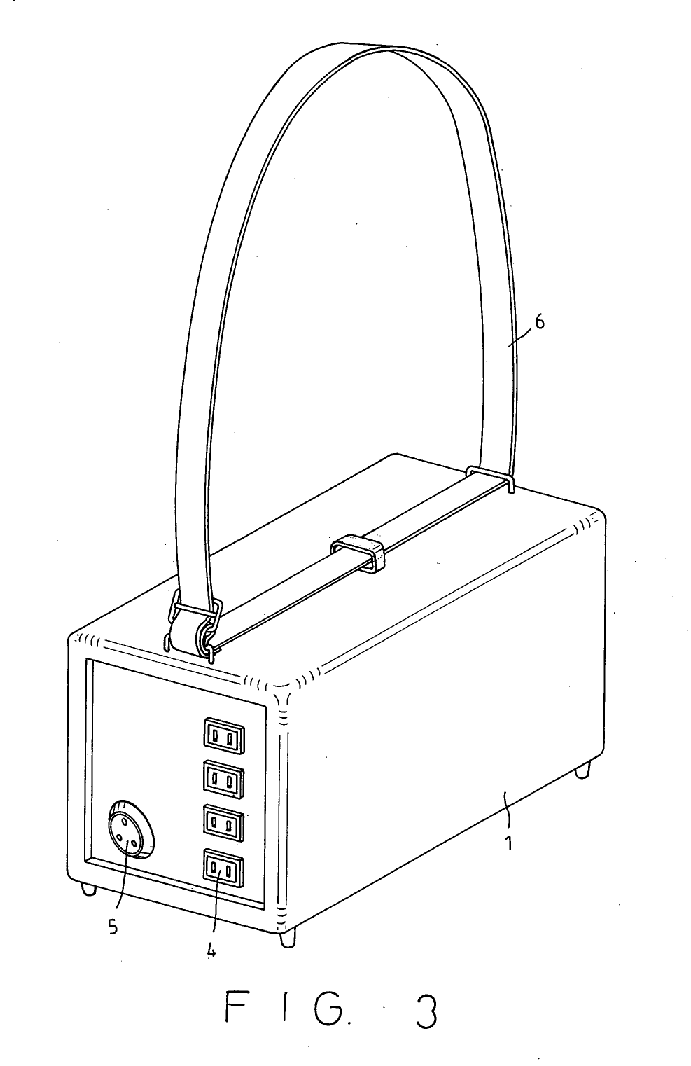

As shown in FIG. 3, the present invention can be provided with a belt (6), which is extendable for facilitating carrying by user. Moreover, some adjustable legs (7) are also capable of being connected with the box (3) to keep the box (3) in stable when it is placed on ground. The leg (7) is made of plastic and is waterproof and quakeproof.

Hence, the present invention obviously obtains improvement and should be allowed for a patent. It is also to be understood that the above-mentioned embodiments are only exemplary of the present invention. Any modification with the same or similar merit is still claimed in this application.

I claim:

1. A portable power supplier including a box, some energy storage apparatus, and an IC board received therein, and the box having several supply sockets and a recharge socket on a side, wherein the energy store apparatus can be charged with energy and the IC board is provided for connecting and transferring energy between the sockets and the apparatus.

2. The portable power supplier as claimed in claim 1, wherein the energy can be a rechargeable battery, an accumulator, a secondary cell, and so on.

3. The portable power supplier as claimed in claim 1, wherein an extendable belt is connected with the box.

4. The portable power supplier as claimed in claim 1, wherein some plastic adjustable legs are connected with the box.
